(19) United States
(12) Patent Application Publication
(10) Pub. No.: US 2011/0028110 A1
(43) Pub. Date: Feb. 3, 2011

(54) RECONFIGURABLE HYBRID ANTENA DEVICE

(75) Inventors: Young Bae Jung, Daejeon (KR); Soon Young Eom, Daejeon (KR); Moon man Hur, Seoul (KR); Soon Ik Jeon, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/674,019

(22) PCT Filed: Aug. 4, 2008
(86) PCT No.: PCT/KR08/04526

§ 371 Date: Feb. 18, 2010

(30) Foreign Application Priority Data
Aug. 21, 2007 (KR) 10-2007-0084009

(51) Int. Cl. H04B 1/04

(52) U.S. Cl. 455/127.1

(57) ABSTRACT

The present invention relates to a reconfigurable hybrid antenna device. According to the present invention, the reconfigurable hybrid antenna device includes a reflective plate that reflects an incident signal and a reconfigurable power supply arrangement that includes one or more element antennas for supplying power to the reflective plate. The reconfigurable power supply arrangement has characteristics of electrical reconfiguration and physical reconfiguration of the element antennas, and reconfiguration of changing a range of radiation of signal powers radiated from the element antennas. With these characteristics of reconfiguration, it is possible to simultaneously or independently provide a plurality of mobile communication services physically using one antenna, such that it is possible to have an economical base station antenna and considerably reduce the number of temporary base stations, thereby reducing the maintenance cost of base stations.

The present invention is based on a project supported by the IT R&D program of MIC/IITA [2007-F-041-01, Intelligent Antenna Technology Development].

### TECHNICAL FIELD

The present invention relates to a reconfigurable hybrid antenna device. More particularly, the present invention relates to a power supply arrangement reconfiguration function of a hybrid antenna device having a reflective plate.

### BACKGROUND ART

Recently, advancements in antenna technology have been strongly required as the concept of an integrated service that is capable of simultaneously providing a plurality of mobile communication services has been on the rise with the development of the next generation mobile communication technology. That is, since wireless communication services have become complex, an antenna that can support the next generation complex terminal service has been required.

However, in general, each of cellular, PCS, W-CDMA, Wibro, and Wi-Fi services needs a corresponding base station antenna in the related art, and simple array antennas having one-dimensional or two-dimensional arrangements using flat plates and linear antenna elements have been used.

According to these array antennas having the above structure in the related art, as described above, a number of antennas are needed for one base station to provide a plurality of mobile communication services that is required for the next generation mobile communication technology. This is the main factor that increases the maintenance cost of base stations, and spoils the appearance of the surroundings.

Further, the array antennas have a drawback in that they are difficult to apply to a MIMO (multi-input multi-output) antenna that is required for a high-speed large capacity communication service, which is the core of the next generation mobile communication technology.

FIG. 1, FIG. 2, and FIG. 3 are views illustrating the structure of a common hybrid antenna that has been used in the related art.

According to FIG. 1, FIG. 2, and FIG. 3, a common structure of a hybrid antenna includes a reflective plate 10, and power supply arrangement 20 having one or more element antennas 21 that are power supply elements for supplying power to the reflective plate 10.

According to the structure, depending on the direction of signal power radiated from the power supply arrangement 20, the traveling direction P11 of a final wave reflected by the reflective plate 10 is determined.

FIG. 1 illustrates when the direction of the signal power radiated from the power supply arrangement 20 is a normal direction. That is, the signal power radiated from the power supply arrangement 20 travels into a free space, depending on the relative incident angle to the surface of the reflective plate 10. The traveling direction P11 of the final radio wave reflected by the reflective plate 10 is also the normal direction.

FIG. 2 and FIG. 3 illustrate when signal powers are radiated in the left and right directions from the power supply arrangement 20, respectively. Also in FIG. 2 and FIG. 3, the directions P11 of the final radio wave reflected by the reflective plate 10 are the left and right directions, respectively.

As described above, the function has been limited to controlling the direction of a radio wave that is transmitted (or received) from the hybrid antenna in the related art.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a reconfigurable hybrid antenna device having advantages of allowing a base station antenna to operate in multiband or wideband and having a function of reconfiguration to efficiently achieve a function of an MIMO antenna for the next generation mobile communication.

### Technical Solution

A reconfigurable hybrid antenna device according to the present invention includes: a reflective plate that reflects an incident signal; a power supply arrangement that includes a plurality of element antennas for supplying power to the reflective plate; active channels that control the levels and phases of signal powers radiated from the element antennas of the power supply arrangement; and a controller that is connected with the active channels and outputs control values for the levels and phases of signal power that is inputted and outputted to/from the element antennas to change a range of radiation of the signal powers radiated from the element antennas.

According to the present invention, it is possible to simultaneously or independently provide a plurality of mobile communication services by controlling the power supply arrangement having a function of reconfiguration to turn on/off the element antennas of the power supply arrangement.

Further, the surface of the reflective plate is formed in one dimension or two dimensions, such that it is possible to achieve high-gain characteristics and an optimum radiation pattern required for a mobile communication service.

### Advantageous Effects

According to this structure of a reflective plate-based hybrid antenna, since the power supply arrangement including a plurality of element antennas is electrically and physically controlled, it is possible to achieve reconfiguration of the frequency and operation of the entire antenna and provide an advantage of achieving an economical base station antenna that can provide a high-quality communication service required for the next generation mobile communication service.

Therefore, since it is possible to provide a plurality of mobile communication services from one base station, it is possible to considerably reduce the number of temporary base stations and accordingly reduce the maintenance cost of base stations.

### BRIEF DESCRIPTION OF THE DRAWINGS

FIG. 1, FIG. 2, and FIG. 3 are views illustrating the structure of a common hybrid antenna in the related art.

FIG. 4 is a view illustrating the structure of a reconfigurable hybrid antenna according to an exemplary embodiment of the present invention.

FIG. 5 is a view illustrating an active power supply unit of a reconfigurable hybrid antenna according to an exemplary embodiment of the present invention.

FIG. 6 to FIG. 9 are views illustrating the structure of a reconfigurable hybrid antenna where electrical reconfiguration is applied, according to an exemplary embodiment of the present invention.

FIG. 10 and FIG. 11 are views illustrating the structure of a reconfigurable hybrid antenna where physical reconfiguration is applied, according to an exemplary embodiment of the present invention.

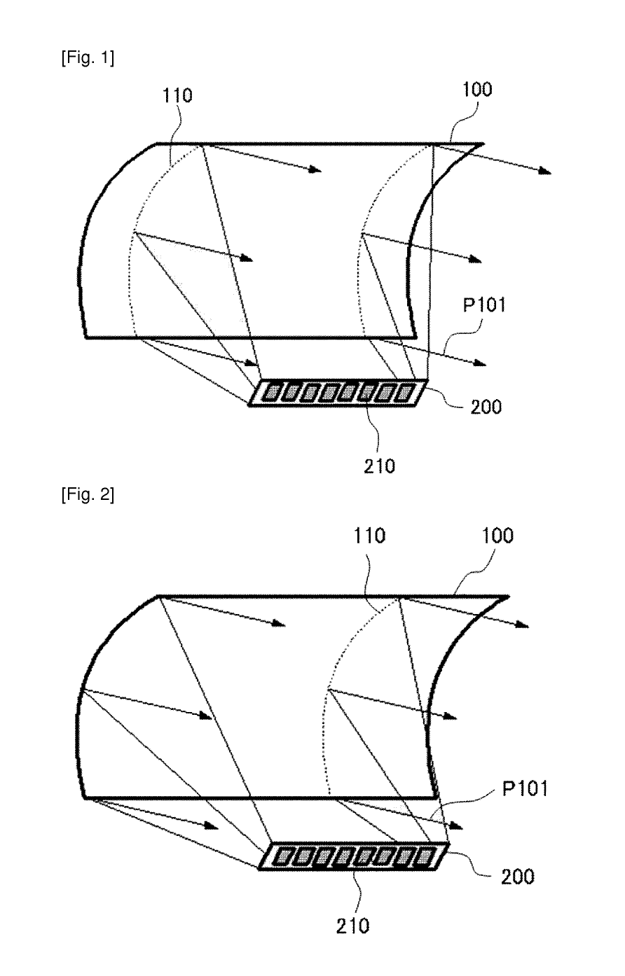

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be further understood that the terms “comprises” and/or “comprising,” when used in this specification, specify the presence of stated components, but do not preclude the presence or addition of one or more other components, unless specifically stated. In addition, the terms -er, -or, module, and block described in the specification mean units for processing at least one function and operation, and can be implemented by hardware components or software components, and combinations thereof.

Hereinafter, a reconfigurable hybrid antenna device according to an exemplary embodiment of the present invention is described in detail with reference to the accompanying drawings. Like reference numerals designate like elements in the drawings.

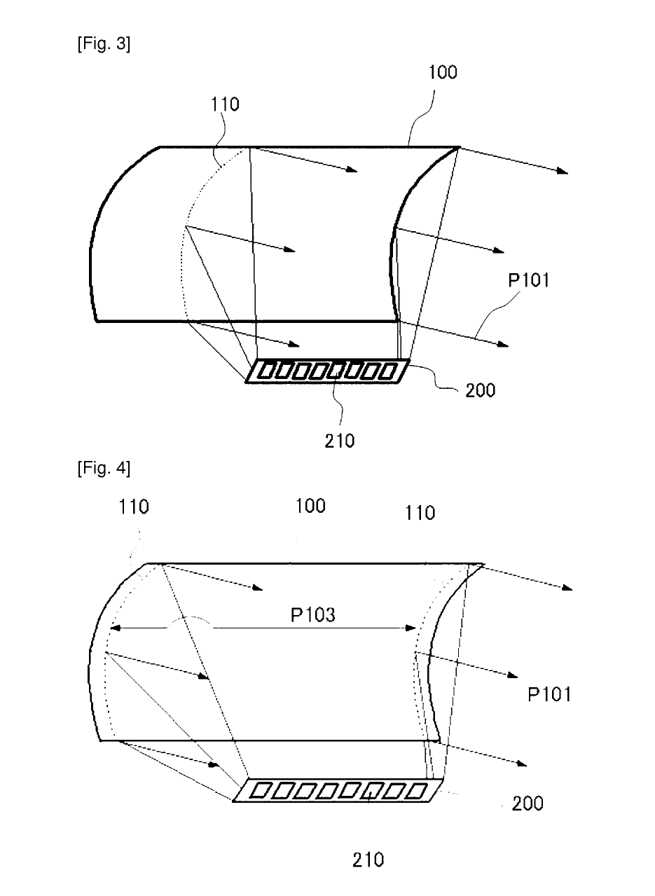

FIG. 4 is a view illustrating the structure of a reconfigurable hybrid antenna according to an exemplary embodiment of the present invention.

According to FIG. 4, a reconfigurable hybrid antenna includes a reflective plate 100 that reflects an incident signal, and a reconfigurable power supply arrangement 200 that includes a plurality of element antennas 210 supplying power to the reflective plate 100 and that controls the traveling direction P101 of the final radio wave reflected by the reflective plate 100.

According to this configuration, the element antennas 210 of the reconfigurable power supply arrangement 200 can independently turn on/off, as the reconfigurable power supply arrangement 200 has a reconfiguration function that activates all or some of the element antennas 210 of the reconfigurable power supply arrangement 200.

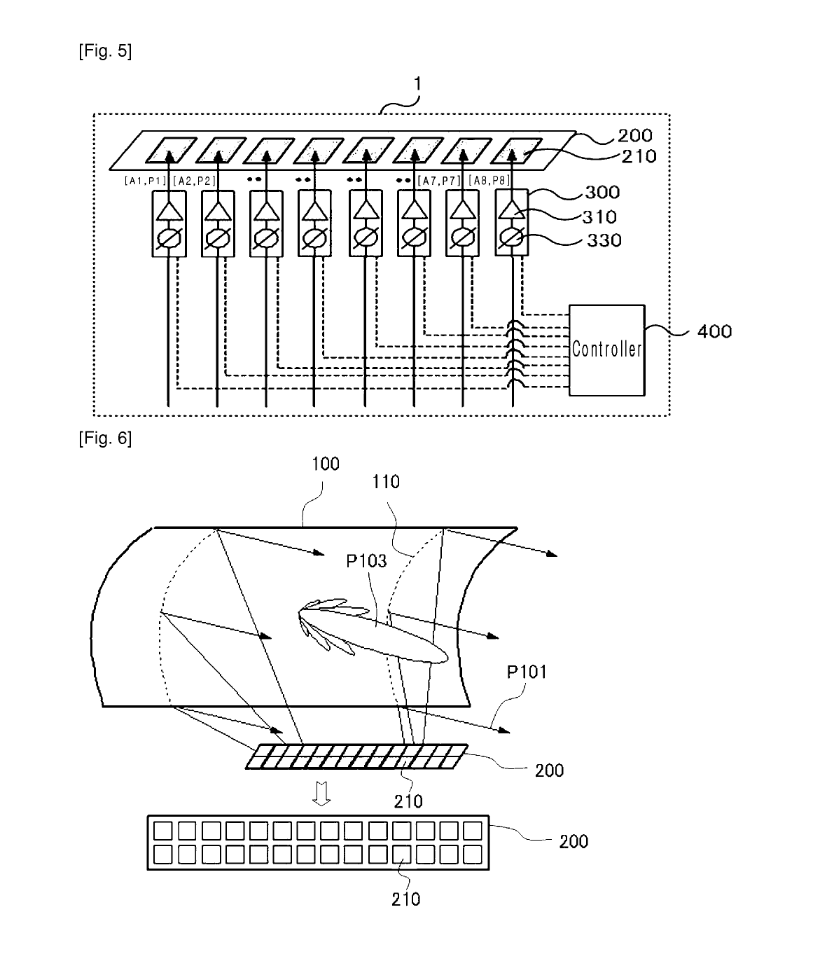

Further, as shown in FIG. 5, it is possible to control the level and phase of signal power radiated from the element antennas 210 using active channels 300 that are independently connected to the element antennas 210, such that it is possible to change the range of radiation P103 of signal power radiated from the power supply arrangement 200. The range of radiation P103 implies the horizontal distance between the reflective plate 100 and an effective aperture boundary 110.

The range of radiation P103 implies the width of a beam pattern that is formed and the width of the beam pattern is directly associated with service coverage, so it is possible to actively change the service coverage by changing the range of radiation P103. As the range of radiation is variable, it is possible to actively change the service area under a communication environment in which the reconfigurable hybrid antenna operates, thereby improving the operational efficiency.

Further, although not illustrated in detail in the figures, it is possible to achieve high-gain characteristics by forming the surface of the reflective plate 100 in one dimension or two dimensions and applying an optimum radiation pattern required for mobile communication service.

To help understating the function of controlling the width of the beam pattern of the reconfigurable hybrid antenna, which is the object intended in the figures, the figures illustrate that all element antennas 210 are activated, but it should be understand that the function of controlling the width of the beam pattern by turning on some of the element antennas 210 can also be applied.

FIG. 5 is a view illustrating an active power supply unit of a reconfigurable hybrid antenna according to an exemplary embodiment of the present invention.

According to FIG. 5, an active power supply unit 1 includes the reconfigurable power supply arrangement 200 that changes the range of radiation (P103 of FIG. 4) as described in reference to FIG. 4, and the active channels 300.

The reconfigurable power supply arrangement 200 is composed of the plurality of element antennas 210 that transmit and receive the signal power.

The active channel unit 300 controls the level and phase of the signal power radiated from the reconfigurable power supply arrangement 200. In detail, the active channel unit 300 includes an amplifier 310 that controls the level of the signal power, and a phase shifter 330 that controls the phase. The active channels 300 illustrated in the figure are active channels for transmission, but it is apparent that the active channels 300 are also conceptually the same as active channels for receipt.

A controller 400 is connected with each of the active channels 300, and controls the operation for controlling the level and phase of the signal power of the active channels 300 for changing the range of radiation P103. Further, the controller 400 is connected with the active channels 300 and controls the operation of turning on/off the reconfigurable power supply arrangement 200.

That is, the controller 400 sets control values for the levels and phases of the signal powers of the active channels 300, and actively changes the range of radiation P103 of the reconfigurable power supply arrangement 200. In the figure, the solid lines represent the input/output lines of RF signal power and main signal source, from the active channels 300, and the dotted lines represent the output line of the control value for the level and phase of the signal power inputted into the active channels 300 from the controller 400.

Further, the controller 400 actively changes the range of radiation P103 of the reconfigurable power supply arrangement 200 by turning on/off the element antennas 210 of the reconfigurable power supply arrangement 200.

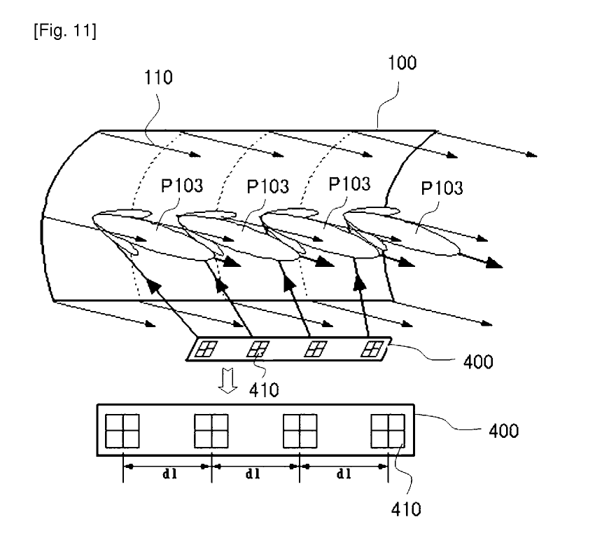

FIG. 6 to FIG. 11 illustrate two ways of reconfiguration by a hybrid antenna according to an exemplary embodiment of the present invention. FIG. 6 to FIG. 9 illustrate the structure of an electrical reconfigurable hybrid antenna, and FIG. 10 and FIG. 11 illustrate the structure of a mechanical reconfigurable hybrid antenna.

First, FIG. 6 to FIG. 9 are views illustrating the structure of a reconfigurable hybrid antenna where electrical reconfiguration is applied, according to an exemplary embodiment of the present invention.

The reconfigurable power supply arrangement 200 shown in FIG. 6 to FIG. 9 is composed of common element antennas 210 including wideband characteristics and multiband characteristics. The common element antenna 210 implies inclusive conception, including wideband element antennas and multiband element antennas that have electrical characteristics, such that they can be activated within frequency bandwidths of a plurality of mobile communication services.

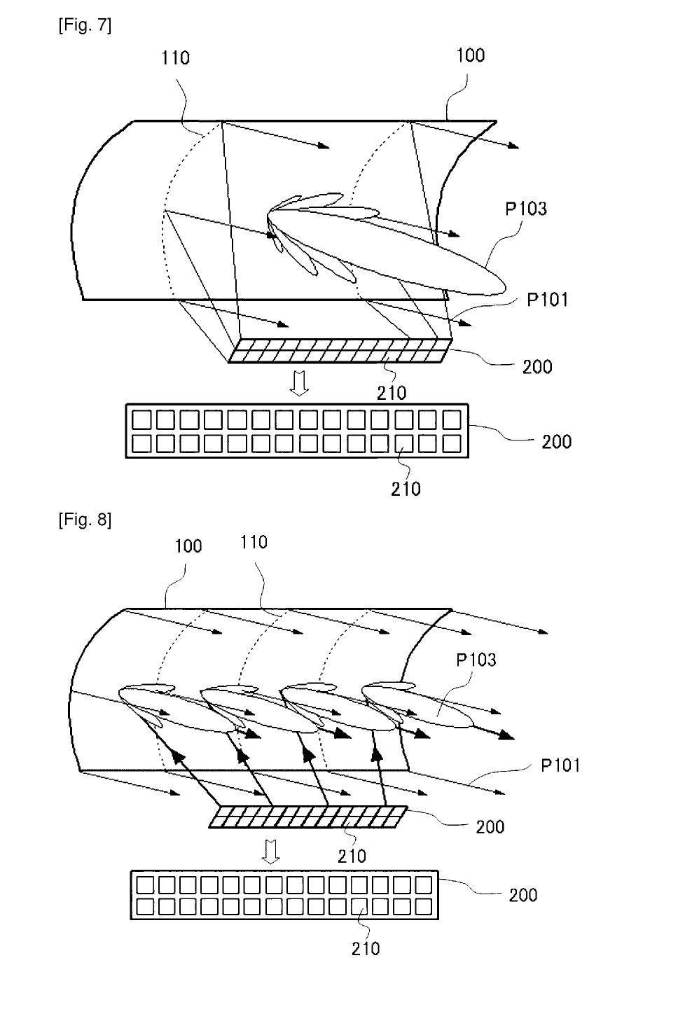

FIG. 6 shows that only sixteen element antennas 210 at the center portion are turned on of all the element antennas 210, and FIG. 7 shows that all of the element antennas 210 are turned on. In FIG. 6 and FIG. 7, an integral beam pattern P105 is formed by electrical connection between the turned-on element antennas 210.

Further, depending on the number of element antennas 210 that are in activation, the effective aperture of the power supply arrangement 200 changes, and accordingly the width and gain of the beam P105 of the final antenna reflected by the reflective plate 100 is variable. However, it is assumed in the figures that the levels and phases of the signal powers radiated from the element antennas 210 of the power supply arrangement 200 are the same. Accordingly, it can be seen from FIG. 7 that the gain of the antenna beam P105 is relatively large and the beam width is small.

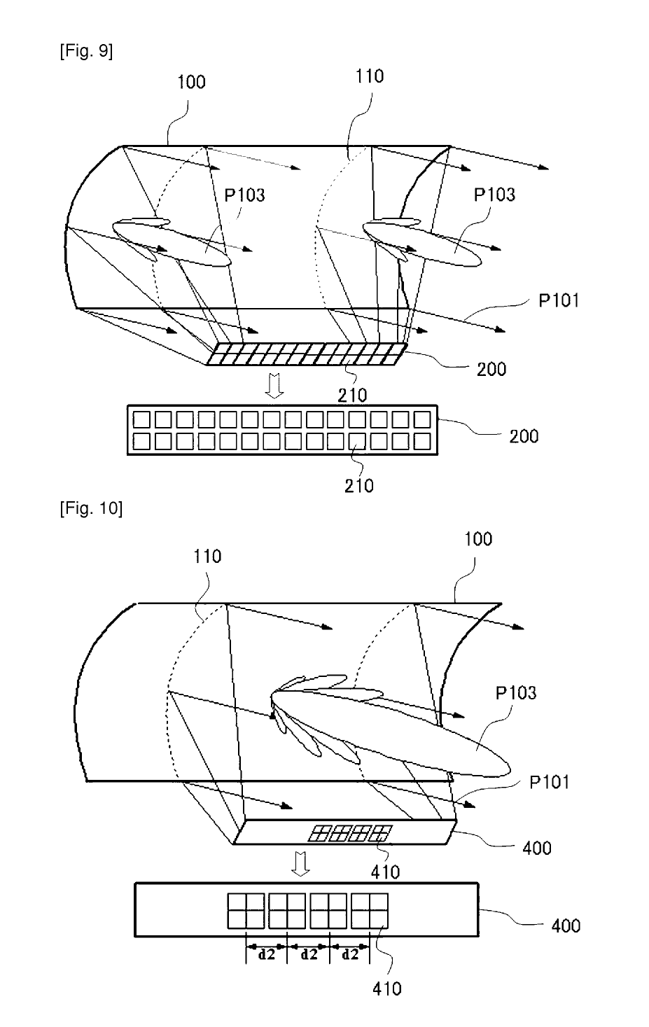

FIG. 8 shows that only some element antennas 210 in four regions spaced apart at a predetermine distance are turned on and FIG. 9 shows that only some element antennas 210 in two regions at both ends of the reconfigurable power supply arrangement 220 are turned on.

In FIG. 8 and FIG. 9, there is no electrical connection between the signal powers radiated from the element antennas 210 in the four regions and the two regions, respectively, and accordingly, four independent beam patterns P105 and two independent patterns P105 are formed, respectively.

FIG. 10 and FIG. 11 are views illustrating the structure of a reconfigurable hybrid antenna where mechanical reconfiguration is applied, according to an exemplary embodiment of the present invention.

A multi-reconfigurable power supply arrangement 500 shown in FIG. 10 and FIG. 11 includes a plurality of multi-element antennas 510 that are disposed at different positions and activated in different service bands.

The multi-element antennas 510 are shown in the figures to illustrate structural variety of the element antennas 210 of the power supply arrangement 200 included in the reconfigurable hybrid antenna of the invention, but the shape and specification of the element antennas 210 can be freely changed by a designer.

Further, FIG. 10 to FIG. 11 illustrates the structure of the reconfigurable hybrid antenna that changes the range of radiation P103 by changing the physical distances between the element antennas 210 while the control values for the levels and phases of the signal powers set by the controller (400 in FIG. 5).

FIG. 10 illustrates when the distance between the multi-element antennas 210 of the multi-reconfigurable power supply arrangement 500 is d2. The distance d2 is a distance that allows the signal powers radiated from multi-element antennas 410 to be electromagnetically mixed. Therefore, as shown in FIG. 5A, the integral beam P105 is formed.

FIG. 11 illustrates when the distance between the multi-element antennas 510 of the multi-reconfigurable power supply arrangement 500 is dl. The distance d1 is a distance that prevents the signal powers radiated from the multi-element antennas 410 from having an electromagnetic effect on each other. Therefore, as shown in FIG. 8 and FIG. 9, the plurality of independent beam patterns P105 are formed.

Further, though not shown in FIG. 10 and FIG. 11, it is possible to freely adjust the number of independent beam patterns P103 by controlling the multi-element antennas 410 to turn on/off.

As described above, according to a reconfigurable hybrid antenna of an exemplary embodiment of the present invention, it is possible to achieve the effect of operating a plurality of antennas by using one physical antenna, so it is very efficient to achieve the function of an MIMO antenna for the next generation mobile communication.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A reconfigurable hybrid antenna device comprising:
a reflective plate that reflects an incident signal;
a power supply arrangement that includes a plurality of element antennas for supplying power to the reflective plate;
active channels that control the levels and phases of signal powers radiated from the element antennas of the power supply arrangement; and
a controller that is connected with the active channels and outputs control values for the levels and phases of signal powers that are inputted and outputted to/from the element antennas to change a range of radiation of the signal powers radiated from the element antennas.

2. The device of claim 1, wherein the controller turns on/off the element antennas of the power supply arrangement.

3. The device of claim 1, wherein the power supply arrangement includes a plurality of element antennas that are activated within a multiband or a wide band.

4. The device of claim 3, wherein the controller turns on element antennas that are spaced apart by a distance from each other such that the element antennas have an electromagnetic effect on each other to form one integral beam pattern, in the plurality of element antennas.

5. The device of claim 3, wherein the controller turns on element antennas that are spaced apart by a distance from each other such that the element antennas do not have an electromagnetic effect on each other to form two or more different beam patterns, in the plurality of element antennas.

6. The device of claim 1, wherein the power supply arrangement changes the distances between the element antennas of the power supply arrangement.

7. The device of claim 6, wherein the power supply arrangement includes element antennas that are spaced apart from each other such that element antennas have an electromagnetic effect on each other to form one integral beam pattern.

8. The device of claim 6, wherein the power supply arrangement includes element antennas that are spaced apart from each other such that the element antennas do not have an electromagnetic effect on each other to form two or more different beam patterns.

9. The device of claim 1, wherein the surface of the reflective plate is formed in one dimension or two dimensions.
